(19) United States
(12) Patent Application Publication
(10) Pub. No.: US 2021/0218463 A1
(43) Pub. Date: Jul. 15, 2021

(54) SYSTEM AND METHOD FOR CONTROLLING DATA TRANSMISSION

(71) Applicant: Ubees Lab, Seoul (KR)

(72) Inventors: Gun Woo HWANG, Seoul (KR); Joon Hyup SEO, Seoul (KR)

(73) Assignee: Ubees Lab, Seoul (KR)

(21) Appl. No.: 17/109,861

(22) Filed: Dec. 2, 2020

(30) Foreign Application Priority Data
Jan. 10, 2020 (KR) 10-2020-0003692

(51) Int. Cl. H04B 7/155; H04L 29/08; H04W 88/04; H04W 76/18; H04W 4/38

(52) U.S. Cl. CPC H04B 7/15521; H04L 67/303; H04W 4/38; H04W 76/18; H04W 88/04

(57) ABSTRACT

Provided are a system and method for controlling data transmission. The method includes receiving a list of registered sensor devices by executing a preregistered application with which information on one or more user sensor devices is registered, and receiving data from the sensor devices on the basis of the received list of sensor devices.

### CROSS-REFERENCE TO RELATED APPLICATION

This application claims priority to and the benefit of Korean Patent Application No. 10-2020-0003692, filed on Jan. 10, 2020, the disclosure of which is incorporated herein by reference in its entirety.

### BACKGROUND

### 1. Field of the Invention

The present invention relates to a system and method for controlling data transmission, and more particularly, to a data transmission control system and method for receiving data from multiple sensor devices in sequence.

### 2. Discussion of Related Art

The present invention relates to a system in which global positioning system (GPS) location data acquired from sensor devices worn on the bodies of players in a soccer game is transmitted to a server and activity information of the players regarding the game is collectively analyzed. The analysis deals with travel distance, highest speed, the number of sprints, activity range, etc. of the players during the game.

Professional soccer clubs have used this technology for some years, and some clubs have had good records with systematic team administration and game handling based on data. For this reason, even in the field of soccer, a general consensus is being made about the necessity of data.

However, a soccer data analysis technology used by professional soccer clubs employs a complicated system to acquire, transmit, and analyze the activity amounts of players.

Since this system includes high-priced equipment, only some rich clubs can experience the usefulness thereof.

The present invention relates to a method of transmitting data from sensor devices to a server which is necessary for a change from an existing high-priced and complicated soccer data analysis solution to a soccer data analysis solution that may be easily used by anyone at a reasonable price.

Meanwhile, some youth or amateur players who do not have high-priced equipment use wearable devices, such as fitness trackers or smart watches, to measure their activity amounts (travel distance and highest speed). However, such wearable devices are individual devices. One sensor device can transmit data to only one mobile communication terminal, and each individual having a sensor device should transmit data through his or her own mobile communication terminal.

Accordingly, in the case of team sports such as soccer requiring data of all eleven players, it is difficult to collect all of the group data when any one of the eleven players is uncooperative such as by not transmitting his or her data.

The present invention relates to a method of overcoming the inconvenience and allowing one mobile communication terminal to download data of sensor devices of all players in a group even when each individual does not control his or her sensor device with his or her mobile communication terminal.

### SUMMARY OF THE INVENTION

The present invention is directed to providing a data transmission control system and method for receiving data from multiple sensor devices.

Objects of the present invention are not limited to that mentioned above, and other objects which have not been mentioned will be clearly understood from the following description.

According to an aspect of the present invention, there is provided a data transmission control method for receiving data from multiple sensor devices. The method may include receiving a list of registered sensor devices by executing a preregistered application with which information on one or more user sensor devices is registered, and receiving data from the sensor devices on the basis of the received list of sensor devices.

The method may further include, after the receiving of the data, storing the received data and information on the sensor devices, which transmit the data, in a memory present in a user terminal and transmitting the stored data and information to an external server.

The method may further include, after the storing of the received data and information, transmitting a signal for deleting the data to the sensor devices which transmit the information.

The method may further include, when the information on the sensor devices is registered with the application registered in a user terminal, giving a unique number to each of the sensor devices.

The method may further include, after the receiving of the information list of the registered sensor devices, generating a group including some or all of the registered sensor devices on the basis of the received list of sensor devices.

The receiving of the data may include checking whether transmission from the registered sensor devices included in the generated group is possible and receiving data from the sensor devices from which transmission is possible.

The receiving of the data may include sequentially receiving data from the registered sensor devices in a manner of disconnecting from a first sensor device when data receiving from the first sensor device is finished, connecting to a second sensor device, and receiving data from the second sensor device.

The receiving of the data may include simultaneously receiving data from the registered sensor devices.

The method may further include, after the receiving of the data, displaying a signal asking about whether to perform retransmission on a display of a user terminal when data receiving from a specific device is not finished.

According to another aspect of the present invention, there is provided a data transmission control system for receiving data from multiple sensor devices. The system may include one or more user sensor devices configured to collect data from sensor device wearers, a user terminal configured to receive data from the registered sensor devices, and a server configured to receive the received data from the user terminal.

The user terminal may store, after receiving the data from the sensor devices, the received data and information on the sensor devices, which transmit the data, and transmit the stored data and information to the server.

After storing the data and the information, the user terminal may transmit a signal for deleting the data to the corresponding sensor devices which transmit the information.

The user terminal may give, when the information on the sensor devices is registered with an application registered in the user terminal, a unique number to each of the sensor devices.

The user terminal may generate a group including some or all of the registered sensor devices on the basis of a sensor device list received from the sensor devices.

The user terminal may check whether transmission from the registered sensor devices included in the generated group is possible and receives data from the sensor devices from which transmission is possible.

The user terminal may sequentially receive data from the registered sensor devices in a manner of disconnecting from a first sensor device when data receiving from the first sensor device is finished, connecting to a second sensor device, and receiving data from the second sensor device.

The user terminal may simultaneously receive data from the registered sensor devices.

The user terminal may display a signal asking about whether to perform retransmission on a display of the user terminal when data receiving from a specific device is not finished.

Details for achieving the above objects will become apparent with reference to embodiments described in detail in conjunction with the accompanying drawings.

However, the present invention is not limited to the embodiments disclosed below and may be implemented in various forms. These embodiments are provided so that the disclosure of the present invention will be thorough and complete and will fully convey the scope of the present invention to those of ordinary skill in the art to which the present invention pertains (hereinafter, “those of ordinary skill in the art”).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a flowchart illustrating a data transmission control method for receiving data from multiple sensor devices according to an exemplary embodiment of the present invention;

FIG. 2 is a schematic diagram of a data transmission control system for receiving data from multiple sensor devices according to an exemplary embodiment of the present invention;

FIG. 3 is a diagram of an example in which a terminal checks a unique address from a sensor device according to the exemplary embodiment of the present invention;

FIG. 4 is a diagram of an example in which a terminal checks a list of grouped devices from a server according to the exemplary embodiment of the present invention;

FIG. 5 is a diagram showing an example of a list of sensor devices from which transmission is currently possible on the basis of a sensor device list selected by a terminal according to the exemplary embodiment of the present invention;

FIG. 6 is a diagram of an example of current transmission status of sensor devices displayed on the display of a terminal according to the exemplary embodiment of the present invention; and

FIG. 7 is a diagram of an example of determining whether to perform retransmission in the display of a terminal according to the exemplary embodiment of the present invention when data transmission from a sensor device fails.

### DETAILED DESCRIPTION OF EXEMPLARY EMBODIMENTS

Since the present invention can be variously modified and have various embodiments, specific embodiments will be illustrated in the drawings and described in detail below.

Various features of the present invention disclosed in the claims will be more easily understood with reference to the accompanying drawings and the detailed description thereof. An apparatus, method, manufacturing process, and various embodiments disclosed in this specification are provided for illustration. The disclosed structure and functional features are provided so that those of ordinary skill in the art may implement various embodiments in detail, rather than to limit the scope of the invention. Terms and sentences used herein are provided to describe various features of the invention which are disclosed and not to limit the scope of the invention.

In describing the present invention, a detailed description of relevant known technology will be omitted when determined to obscure the subject matter of the present invention.

Hereinafter, a data transmission control method for receiving data from multiple sensor devices according to an exemplary embodiment of the present invention will be described.

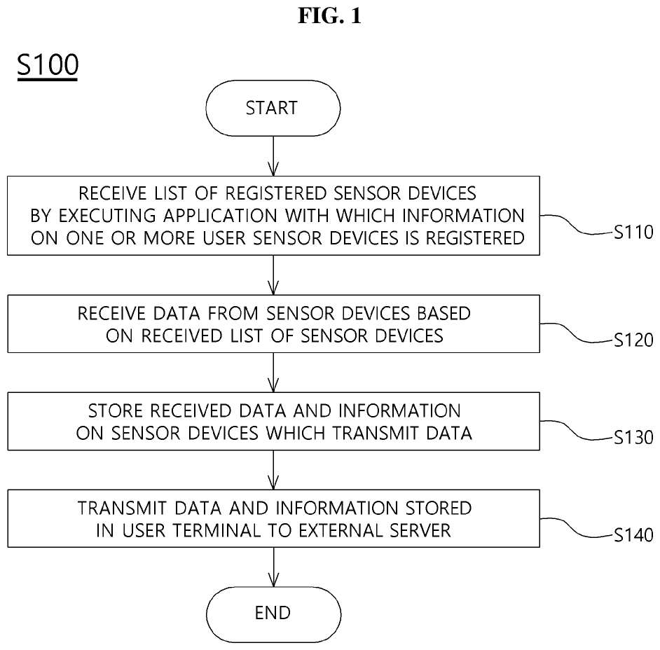

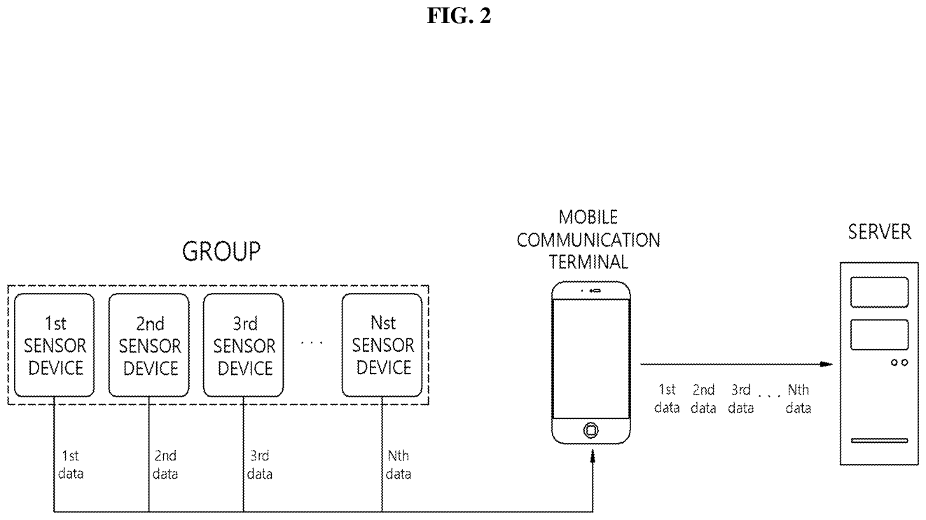

FIG. 1 is a flowchart illustrating a data transmission control method for receiving data from multiple sensor devices according to an exemplary embodiment of the present invention, and FIG. 2 is a schematic diagram of a data transmission control system for receiving data from multiple sensor devices according to an exemplary embodiment of the present invention.

Referring to FIG. 1, a data transmission control method S100 may include an operation S110 of receiving a list of registered sensor devices by executing a preregistered application with which information on one or more user sensor devices is registered and an operation S120 of receiving data from the sensor devices on the basis of the received list of sensor devices.

According to the exemplary embodiment, the operation S110 of receiving a list of sensor devices may be an operation of receiving a list of registered sensor devices by executing a preregistered application with which information on a plurality of user sensor devices is registered. A user may register sensor device information with his or her account of the application in advance. Accordingly, a user terminal may receive a previously registered sensor device list through the application and receive data from sensor devices registered in the list. Consequently, it is possible to reduce unnecessary time spent on repetition of establishing and canceling a device connection for every transmission of data or information.

According to the exemplary embodiment, before the operation S110 of receiving a list of sensor devices, the data transmission control method S100 may further include an operation of giving a unique number to each of sensor devices when information of a plurality of user sensor devices is registered through the application of the user terminal in advance. More specifically, unique numbers are given to sensor devices registered with the application of the user terminal, and thus it is possible to shorten a process of checking device information during the subsequent operation of receiving data, which is efficient.

According to the exemplary embodiment, the operation S120 of receiving data may be an operation of receiving data from the sensor devices on the basis of the received list of registered sensor devices.

More specifically, the operation S120 of receiving data may further include an operation of generating a group including some or all of the registered sensor devices on the basis of the received list of sensor devices. According to the data transmission control method S100, a group suitable for the user's purpose of use may be generated through the operation of generating a group so that data and information of desired devices may be received together. Also, the operation S120 of receiving data may further include an operation of additionally generating various groups according to the user's usage.

Also, the operation S120 of receiving data may include an operation of checking whether transmission from the registered sensor devices included in the generated group selected by the user is possible and receiving data from the sensor devices from which transmission is possible.

More specifically, the operation of checking whether transmission is possible may be an operation of checking whether transmission from the registered sensor devices included in the group is currently possible. Before data transmission from the registered sensor devices included in the generated group, whether data transmission is currently possible may be determined through the operation of checking whether transmission is possible so that a device status in which data transmission is not possible (e.g., full discharge of device power or a communication failure) may be checked. In this way, errors in data transmission may also be prevented.

In the operation S120 of checking whether transmission is possible, status of a plurality of devices may be determined by checking a unique address given to each of the devices, and whether data transmission is possible may be determined by determining status of the devices. The operation of receiving data may be an operation of receiving data from one or more sensor devices of which data transmission is checked to be possible.

The operation S120 of receiving data may be an operation of sequentially receiving data from devices from which transmission is possible in the group in a manner of disconnecting from a first sensor device when data receiving from the first sensor device is finished, connecting to a second sensor device, receiving data from the second sensor device, disconnecting from the second sensor device, connecting to a third sensor device, and receiving data from the third sensor device.

Alternatively, when the user terminal supports multi-connection, the user terminal may be simultaneously connected to a plurality of devices included in a group selected by the user and receive data all together. Since the user terminal is simultaneously connected to a plurality of sensor devices and receives multiplex transmissions, it is possible to reduce the time spent on receiving transmission data.

According to the exemplary embodiment, after the operation S120 of receiving data, the data transmission control method S100 may further include an operation S130 of storing the received data and information on sensor devices, which transmit the data, in a memory present in the user terminal and an operation S140 of transmitting the stored data and information to an external server.

More specifically, after the operation S120 of receiving data, the user terminal may store data received from a plurality of sensor devices and received device information together. The user terminal stores the received data together with the received device information in order to accurately determine from which device the data is received and to determine, when there is an error in data received thereafter, from which device the data is received and receive the data again. Also, the data and information stored in the user terminal may be transmitted to an external server for backup.

According to the exemplary embodiment, after storing the received data and information, the user terminal may transmit a signal for deleting the data, which has been transmitted, to the corresponding sensor devices which have transmitted the data. The operation is intended to delete data of a device from which transmission has been finished normally and makes the device able to collect subsequent data. After data transmission, a device receiving the data deletion signal may delete the data and may be immediately powered off. Data deletion and a power-off signal of the sensor device may be checked through a light-emitting diode (LED) indicator of sensor devices which is present outside the sensor device.

For example, when transmission of collected data is finished, a sensor device may receive a data deletion signal from the user terminal which receives the data, may delete the stored data, and may be immediately powered off so that battery consumption may be reduced. Completion of data deletion and power of the sensor device may be checked through a change in the color of the LED indicator present outside the sensor device. The example is only for illustrating the present invention, and the present invention is not limited thereto.

According to the exemplary embodiment, the data transmission control method S100 may further include, after the operation of receiving of data, displaying a signal asking about whether to perform retransmission on the display of the user terminal when data receiving from a specific device is not finished. More specifically, when data receiving is not finished normally, the user terminal may transmit a signal asking about whether to perform retransmission to the user by displaying a list of devices from which data receiving is finished abnormally.

The above-described method allows several sensor devices to transmit data using a general-purpose terminal as a control device. The method does not require existing special-purpose equipment for controlling a plurality of sensor devices and a structure for fixing the plurality of sensor devices at one place. Consequently, it is possible to increase convenience in data transmission and reduce costs.

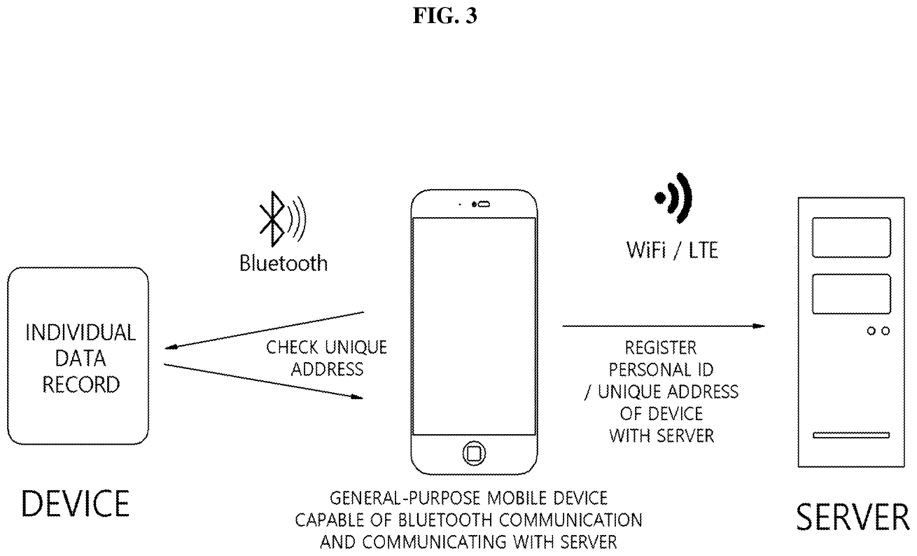

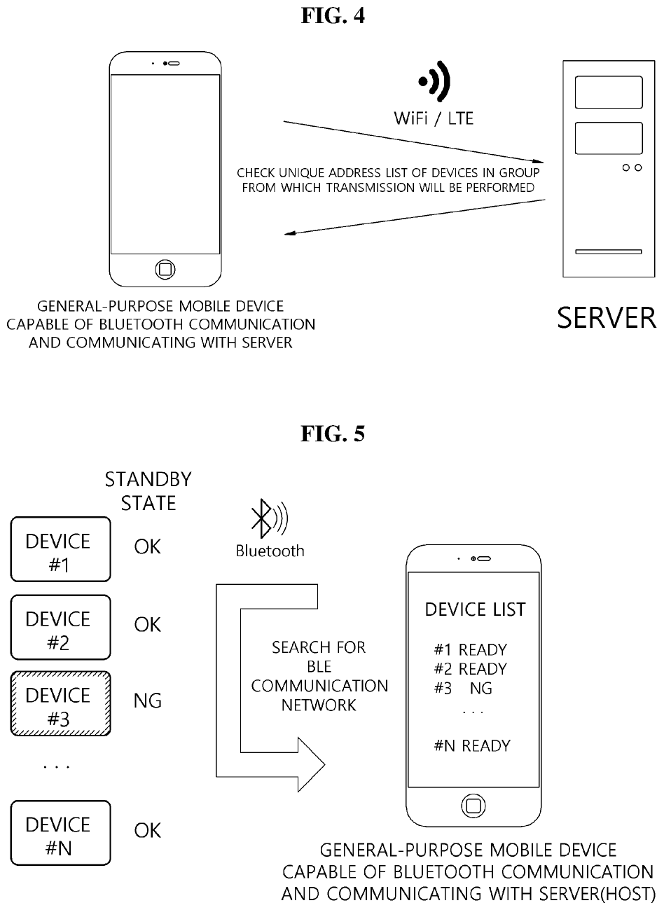

FIG. 2 is a schematic diagram of a data transmission control system for receiving data from multiple sensor devices according to an exemplary embodiment of the present invention. FIG. 3 is a diagram of an example in which a terminal checks a unique address from a sensor device according to the exemplary embodiment of the present invention, and FIG. 4 is a diagram of an example in which a terminal checks a list of grouped devices from a server according to the exemplary embodiment of the present invention.

Referring to FIGS. 2 to 4, the data transmission control system may include one or more user sensor devices which collect data from users, a user terminal which receives data from registered sensor devices, and an external server which receives the received data from the user terminal.

According to the exemplary embodiment, the sensor devices may collect data from each sensor device wearer. One or more sensor devices may be registered in advance through a user account of an application on the user terminal. For example, data collected by the sensor devices may be information related to any motion of the sensor devices such as movement distance, instantaneous speed, cumulative movement distance, and movement direction. The example is only for illustrating the present invention, and the present invention is not limited thereto.

According to the exemplary embodiment, the user terminal may receive a list of the registered sensor devices by executing an application which interoperates with a memory storing information on a plurality of user sensor devices. In other words, the user terminal may execute the application to receive a list of one or more sensor devices through the application, which is executed in association with information preregistered in the memory, and to receive data from the sensor devices included in the received list. Accordingly, it is possible to reduce unnecessary time spent on repetition of establishing and canceling a device connection for every information transmission.

According to the exemplary embodiment, when information of the plurality of user sensor devices is registered through the application of the user terminal, the user terminal may give a unique number to each of the sensor devices in advance. Unique numbers are given to sensor devices registered through the application of the user terminal, and thus it is possible to reduce a process of checking device information during a subsequent operation of receiving data, which is efficient.

According to the exemplary embodiment, the user terminal may receive data from the sensor devices on the basis of the received list of registered sensor devices. In other words, the user terminal may receive the list of sensor devices which are registered with the application in advance and may receive data from the sensor devices included in the received sensor device list.

Also, the user terminal may generate a group including some or all of the registered sensor devices on the basis of the received sensor device list. The user terminal may generate a group suitable for the user's purpose of use in advance and then receive data and information of desired devices all together simply by selecting the group.

Further, the user terminal may check whether transmission from the registered sensor devices included in the generated group is possible and receives data from the sensor devices from which transmission is possible.

More specifically, before data transmission, the user terminal may perform a process of checking whether transmission from the registered sensor devices included in the group selected by the user terminal is currently possible. The user terminal may determine device status (e.g., full discharge of device power, a communication failure, or a data error) through the process of determining whether transmission is possible. Also, errors in data transmission may be prevented through the process. In the process of determining whether data transmission is possible, the user terminal may communicate with a device in a manner of checking a unique address given to each device, determine whether data transmission is possible by checking status of the checked device, and display the corresponding information on the device display.

According to the exemplary embodiment, the user terminal may sequentially receive data from the sensor devices from which transmission is possible through the above process.

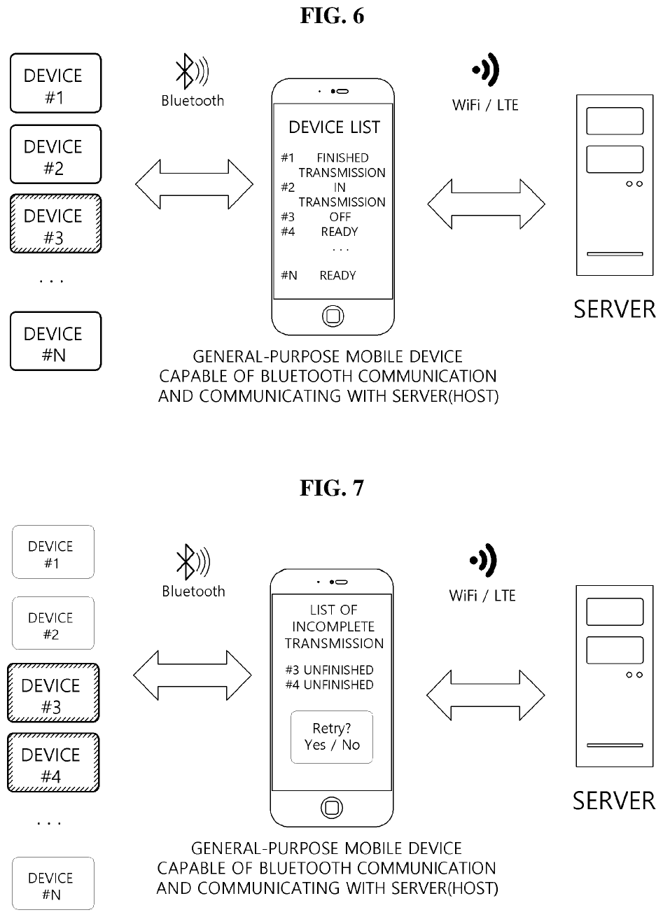

More specifically, FIG. 5 is a diagram showing an example of status of a list of sensor devices from which transmission is currently possible on the basis of a sensor device list selected by a terminal according to the exemplary embodiment of the present invention, and FIG. 6 is a diagram of an example of current transmission status of sensor devices displayed on the display of a terminal according to the exemplary embodiment of the present invention.

Referring to FIGS. 5 and 6, the user terminal may receive data from devices from which transmission is possible in a group in a manner of disconnecting from a first sensor device when data receiving from the first sensor device is finished, connecting to a second sensor device, receiving data from the second sensor device, disconnecting from the second sensor device, connecting to a third sensor device, and receiving data from the third sensor device.

Alternatively, when the user terminal supports multi-connection, the user terminal may be simultaneously connected to a plurality of devices included in a group selected by the user and receive all of the data at once. Since the user terminal is simultaneously connected to a plurality of sensor devices and receives multiplex transmissions, it is possible to reduce the time spent on receiving transmission data.

Data is received from an existing sensor device through connection with and disconnection from a user terminal on a one-to-one basis. In the case of a plurality of sensor devices, the process is complicated and takes a long time due to repeated establishment and canceling of a connection with each of the sensor devices. However, when devices are registered in advance through a user account of an application according to the method proposed by the present invention, it is possible to sequentially receive data from a plurality of devices through a simple process of receiving information from the devices registered with the account.

According to the exemplary embodiment, after data is received, the user terminal may store the received data together with information on sensor devices which transmit the data and transmit the data and information stored in the user terminal to the server for backup.

More specifically, after receiving data from a plurality of sensor devices, the user terminal may store the data and device information received from each of the sensor devices together. The user terminal stores the received data and device information together in order to accurately determine that the data is received from a specific device and to easily determine, when there is an error in data or information, from which device the data or information is received. Also, the data and information stored in the user terminal may be transmitted to the server for backup.

According to the exemplary embodiment, after storing the received data and information, the user terminal may transmit a signal for deleting the data to the corresponding sensor devices which have transmitted the data. The operation is intended to delete data of a device from which transmission has been finished normally and makes the device able to collect subsequent data. After data transmission is finished, a device receiving the data deletion signal may delete the data and may be immediately powered off. Data deletion and a power-off signal of the sensor device may be checked through an LED indicator of sensor devices which are present outside the sensor device.

FIG. 7 is a diagram of an example of determining whether to perform retransmission in the display of a terminal according to the exemplary embodiment of the present invention when data transmission from a sensor device fails. Referring to FIG. 7, when data receiving from a specific device is not finished during a process of receiving data, the user terminal may notify the user that data receiving is not finished normally and may display a question of whether to receive a retransmission signal from the sensor device on the display of the user terminal. More specifically, when data receiving is not finished normally, the user terminal may display a list of devices from which data receiving is not finished normally on the display and transmit a signal to the user asking about whether to perform retransmission.

According to the exemplary embodiment, the server may store information of sensor devices registered through the user account of the application. The server may store unique addresses of the sensor devices for the user terminal to check the sensor devices before data transmission from the sensor devices. The server may store information of a group generated to include some or all of the sensor devices registered with the application. The server may receive and store data, which is received by the user terminal from sensor devices, and information on the sensor devices which transmit the data.

According to an exemplary embodiment of the present invention, in an existing professional solution in which data of N sensor devices is transmitted to a computer, a dock is used, and thus it is possible to transmit data of N sensor devices to only one mobile terminal device. Consequently, convenience is increased.

Also, according to an exemplary embodiment of the present invention, a dedicated dock is unnecessary, and the embodiment can be used by simply installing an application on a mobile communication terminal that anyone has. Consequently, costs can be reduced.

Further, according to an exemplary embodiment of the present invention, one terminal can download all data from multiple sensor devices unlike an existing method in which multiple terminals each transmit their own data. Accordingly, no data is lost, and it is unnecessary to make a data transmission request to each terminal. Consequently, efficiency is increased in data management.

Effects of the present invention are not limited to those mentioned above, and other effects will be clearly understood from the above description.

The descriptions above are merely illustrative of the technical spirit of the present invention, and those of ordinary skill in the art will be able to make various modifications and alterations without departing from the fundamental characteristics of the present invention.

Therefore, exemplary embodiments are disclosed herein, not to limit, but to explain the technical spirit of the present invention, and the scope of the present invention is not to be limited by these embodiments.

The scope of the present invention is to be interpreted from the claims, and all technical concepts within the scope of equivalency are to be construed as falling within the scope of the present invention.

What is claimed is:

1. A method of controlling data transmission, the method comprising:
receiving a list of registered sensor devices by executing a preregistered application with which information on one or more user sensor devices is registered; and
receiving data from the sensor devices on the basis of the received list of sensor devices.

2. The method of claim 1, further comprising, after the receiving of the data, storing the received data and information on the sensor devices, which transmit the data, in a memory present in a user terminal; and
transmitting the stored data and information to an external server.

3. The method of claim 2, further comprising, after the storing of the received data and the information, transmitting a signal for deleting the data to the sensor devices which transmit the information.

4. The method of claim 1, further comprising, when the information on the sensor devices is registered with the application registered in a user terminal, giving a unique number to each of the sensor devices.

5. The method of claim 1, further comprising, after the receiving of the list of registered sensor devices, generating a group including some or all of the registered sensor devices on the basis of the received list of sensor devices.

6. The method of claim 5, wherein the receiving of the data comprises:
checking whether transmission from the registered sensor devices included in the generated group is possible; and
receiving data from the sensor devices from which transmission is possible.

7. The method of claim 1, wherein the receiving of the data comprises sequentially receiving data from the registered sensor devices in a manner of disconnecting from a first sensor device when data receiving from the first sensor device is finished, connecting to a second sensor device, and receiving data from the second sensor device.

8. The method of claim 1, wherein the receiving of the data comprises simultaneously receiving data from the registered sensor devices.

9. The method of claim 1, further comprising, after the receiving of the data, displaying a signal asking about whether to perform retransmission on a display of a user terminal when data receiving from a specific device is not finished

10. A system for controlling data transmission, the system comprising:
one or more user sensor devices configured to collect data from sensor device wearers;
a user terminal configured to receive data from the registered sensor devices; and
an external server configured to receive the received data from the user terminal.

11. The system of claim 10, wherein after receiving the data from the sensor devices, the user terminal stores the received data and information on the sensor devices, which transmit the data, in a memory present in the user terminal and transmits the stored data and information to the external server.

12. The system of claim 11, wherein after storing the data and the information, the user terminal transmits a signal for deleting the data to the corresponding sensor devices which transmit the information.

13. The system of claim 10, wherein when the information on the sensor devices is registered with an application registered in the user terminal, the user terminal gives a unique number to each of the sensor devices.

14. The system of claim 10, wherein the user terminal generates a group including some or all of the registered sensor devices on the basis of a sensor device list received from the sensor devices.

15. The system of claim 14, wherein the user terminal checks whether transmission from the registered sensor devices included in the generated group is possible and receives data from the sensor devices from which transmission is possible.

16. The system of claim 10, wherein the user terminal sequentially receives data from the registered sensor devices in a manner of disconnecting from a first sensor device when data receiving from the first sensor device is finished, connecting to a second sensor device, and receiving data from the second sensor device.

17. The system of claim 10, wherein the user terminal simultaneously receives data from the registered sensor devices.

18. The system of claim 10, wherein the user terminal displays a signal asking about whether to perform retransmission on a display of the user terminal when data receiving from a specific device is not finished.
